(19) United States
(12) Patent Application Publication
(10) Pub. No.: US 2020/0205124 A1
(43) Pub. Date: Jun. 25, 2020

(54) Paging Method, Terminal Device, and Network Device

(71) Applicant: GUANGDONG OPPO MOBILE TELECOMMUNICATIONS CORP., LTD., Dongguan, Guangdong (CN)

(72) Inventor: Jianhua Liu, Dongguan, Guangdong (CN)

(21) Appl. No.: 16/622,846

(22) PCT Filed: Aug. 11, 2017
(86) PCT No.: PCT/CN2017/097264

§ 371 Date: Dec. 13, 2019

(51) Int. Cl. H04W 68/02; H04W 52/02

(52) U.S. Cl. CPC H04W 68/02; H04W 52/0225

(57) ABSTRACT

Methods for paging, a terminal device, and a network device are provided. The method includes: a terminal device determines a first radio frame; the terminal device determines a paging time interval used for monitoring a paging message according to the first radio frame, wherein the paging time interval includes the first radio frame; and the terminal device monitors the paging message in the paging time interval. Therefore, the terminal device may determine the paging time interval used for monitoring the paging message according to the radio frame determined by the terminal device and a position of the radio frame in the paging time interval, and monitor the paging message in the paging time interval.

### CROSS-REFERENCE TO RELATED APPLICATION(S)

This application is a 371 application of International Application No. PCT/CN2017/097264, filed on Aug. 11, 2017, the entire disclosure of which is hereby incorporated by reference.

### TECHNICAL FIELD

Implementations of the present application relate to the field of wireless communication, and more particularly relate to a paging method, a terminal device, and a network device.

### BACKGROUND

When a 5G system works on a high frequency band (i.e., a frequency band greater than 6 GHz), path loss is proportional to the square of frequency change, large loss would occur in a short distance. Therefore, in order to improve reception quality of a signal, the signal will be sent in a mode of beam-forming. When the mode of beam-forming is adopted, for a common signal such as a downlink synchronization signal, a network device will perform beam scan in a cell range according to a certain period, and the scan will be performed in the mode of beam-forming in each period. In this case, when a paging message is sent, the paging message may be sent at a period that is the same as a period of the downlink synchronization signal, and thus multiple Paging Frames (PFs) that can be used for monitoring the paging message may be included within the duration when the downlink synchronization signal is sent each time. Therefore, when the transmission period of the paging message and the transmission period of the synchronization signal are the same, how the terminal device determines the time for receiving the paging message becomes an urgent problem to be solved.

### SUMMARY

Implementations of the present application provide a paging method, a terminal device and a network device.

In a first aspect, there is provided a paging method including: determining, by a terminal device, a first radio frame; determining, by the terminal device, a paging time interval used for monitoring a paging message according to the first radio frame, wherein the paging time interval includes the first radio frame; and monitoring, by the terminal device, the paging message in the paging time interval.

In a possible implementation, the paging time interval is same as a synchronization time interval used for detecting a synchronization signal.

In a possible implementation, determining, by the terminal device, the first radio frame, includes: determining, by the terminal device, that a system frame number of the first radio frame is SFN₁ according to SFN₁ mod T=(T/N)×(UE-ID mod N), wherein T is a time length of a discontinuous reception (DRX) cycle, UE-ID is a device identity of the terminal device, and N is a quantity of radio frames that can be used for sending the paging message in a DRX cycle of the terminal device.

In a possible implementation, determining, by the terminal device, the paging time interval used for monitoring the paging message according to the first radio frame, includes: receiving, by the terminal device, first indication information, wherein the first indication information is used for indicating a position of the first radio frame in the paging time interval; and determining, by the terminal device, the paging time interval according to the position of the first radio frame in the paging time interval.

In a possible implementation, determining, by the terminal device, the paging time interval used for monitoring the paging message according to the first radio frame, includes: determining, by the terminal device, a position of the first radio frame in the synchronization time interval; determining, by the terminal device, that the position of the first radio frame in the synchronization time interval is the position of the first radio frame in the paging time interval; and determining, by the terminal device, the paging time interval according to the position of the first radio frame in the paging time interval.

In a possible implementation, determining, by the terminal device, the paging time interval used for monitoring the paging message according to the first radio frame, includes: determining, by the terminal device, a second radio frame according to the first radio frame and SFN₂=M×SFN₁, wherein an SFN of the first radio frame is SFN₁, an SFN of the second radio frame is SFN₂, and M is a quantity of radio frames included in the paging time interval; and determining, by the terminal device, the paging time interval according to the second radio frame.

In a possible implementation, determining, by the terminal device, the paging time interval according to the second radio frame, includes: receiving, by the terminal device, second indication information, wherein the second indication information is used for indicating a position of the second radio frame in the paging time interval; and determining, by the terminal device, the paging time interval according to the position of the second radio frame in the paging time interval.

In a second aspect, there is provided a paging method including: determining, by a network device, a first radio frame and a paging time interval used for sending a paging message; determining, by the network device, a position of the first radio frame in the paging time interval; and sending, by the network device, first indication information to a terminal device, wherein the first indication information is used for indicating the position of the first radio frame in the paging time interval to enable the terminal device to determine the paging time interval according to the first indication information and monitor the paging message in the paging time interval.

In a possible implementation, the paging time interval is same as a synchronization time interval used for detecting a synchronization signal.

In a possible implementation, determining, by the network device, the first radio frame includes: determining, by the network device, that a system frame number (SFN) of the first radio frame is SFN₁ according to SFN₁ mod T=(T/N)×(UE-ID mod N), wherein T is a time length of a discontinuous reception (DRX) cycle, UE-ID is a device identity of the terminal device, and N is a quantity of radio frames that can be used for sending the paging message in a DRX cycle of the terminal device.

In a possible implementation, determining, by the network device, the position of the first radio frame in the paging time interval includes: determining, by the network device, a position of the first radio frame in the synchronization time interval; and determining, by the network device, that the position of the first radio frame in the synchronization time interval is the position of the first radio frame in the paging time interval.

In a possible implementation, the method further includes: sending, by the network device, third indication information to the terminal device, wherein the third indication information is used for indicating a third radio frame in the paging time interval, to enable the terminal device to monitor the paging message on the third radio frame.

In a third aspect, there is provided a paging method including: determining, by a network device, a second radio frame and a paging time interval used for sending a paging message; determining, by the network device, a position of the second radio frame in the paging time interval; and sending, by the network device, second indication information to a terminal device, wherein the second indication information is used for indicating the position of the second radio frame in the paging time interval, to enable the terminal device to determine the second radio frame according to a first radio frame and the second indication information, determine the paging time interval according to the second radio frame, and monitor the paging message in the paging time interval.

The second radio frame and the first radio frame satisfy SFN₂=Mx SFN₁, an SFN of the first radio frame is SFN₁, an SFN of the second radio frame is SFN₂, and M is a quantity of radio frames included in the paging time interval.

Therefore, by indicating the position of a specific radio frame to the terminal device, the network device enables the terminal device to determine the paging time interval used for monitoring the paging message according to the radio frame and the position of the radio frame in the paging time interval, and to monitor the paging message in the paging time interval. Thus the terminal device can also effectively determine the time for receiving the paging message when a transmission period of the paging message is same as that of a common signal such as a synchronization signal.

In a possible implementation, the paging time interval is same as a synchronization time interval used for detecting a synchronization signal.

In a possible implementation, the first radio frame satisfies SFN₁ mod T=(T/N)×(UE-ID mod N), and the SFN of the first radio frame is determined as the SFN₁, wherein T is a time length of a discontinuous reception (DRX) cycle, UE-ID is a device identity of the terminal device, and N is a quantity of radio frames that can be used for sending the paging message in a DRX cycle of the terminal device.

In a fourth aspect, there is provided a terminal device that may perform operations of the terminal device in the first aspect or any optional implementation of the first aspect. Specifically, the terminal device may include modules used for performing operations of the terminal device in the first aspect or any possible implementation of the first aspect.

In a fifth aspect, there is provided a network device that may perform operations of the network device in the second aspect or any optional implementation of the second aspect. Specifically, the network device may include modules used for performing operations of the network device in the second aspect or any possible implementation of the second aspect.

In a sixth aspect, there is provided a network device that may perform operations of the network device in the third aspect or any optional implementation of the third aspect. Specifically, the network device may include modules used for performing operations of the network device in the third aspect or any possible implementation of the third aspect.

In a seventh aspect, there is provided a terminal device. The terminal device includes: a processor, a transceiver, and a memory. The processor, the transceiver, and the memory communicate with each other through an internal connection path. The memory is used for storing instructions, and the processor is used for executing the instructions stored in the memory. When the processor executes the instructions stored in the memory, the execution causes the terminal device to execute the method in the first aspect or any possible implementation of the first aspect, or the execution causes the terminal device to implement the terminal device provided in the fourth aspect.

In an eighth aspect, there is provided a network device. The network device includes: a processor, a transceiver, and a memory. The processor, the transceiver, and the memory communicate with each other through an internal connection path. The memory is used for storing instructions, and the processor is used for executing the instructions stored in the memory. When the processor executes the instructions stored in the memory, the execution causes the network device to execute the method in the second aspect or any possible implementation of the second aspect, or the execution causes the network device to implement the network device provided in the fifth aspect.

In a ninth aspect, there is provided a network device. The network device includes: a processor, a transceiver, and a memory. The processor, the transceiver, and the memory communicate with each other through an internal connection path. The memory is used for storing instructions, and the processor is used for executing the instructions stored in the memory. When the processor executes the instructions stored in the memory, the execution causes the network device to execute the method in the third aspect or any possible implementation of the third aspect, or the execution causes the network device to implement the network device provided in the sixth aspect.

In a tenth aspect, a computer-readable storage medium is provided. The computer-readable storage medium stores a program that causes a terminal device to perform any paging method of the first aspect and various implementations thereof.

In an eleventh aspect, a computer-readable storage medium is provided. The computer-readable storage medium stores a program that causes a network device to perform any paging method of the second aspect and various implementations thereof.

In a twelfth aspect, a computer-readable storage medium is provided. The computer-readable storage medium stores a program that causes a network device to perform any paging method of the third aspect and various implementations thereof.

In a thirteenth aspect, a system chip is provided. The system chip includes an input interface, an output interface, a processor, and a memory, wherein the processor is used for executing instructions stored in the memory, and when the instructions are executed, the processor may implement the method in the first aspect or any possible implementation of the first aspect.

In a fourteenth aspect, a system chip is provided. The system chip includes an input interface, an output interface, a processor, and a memory, wherein the processor is used for executing instructions stored in the memory, and when the instructions are executed, the processor may implement the method in the second aspect or any possible implementation of the second aspect.

In a fifteenth aspect, a system chip is provided. The system chip includes an input interface, an output interface, a processor, and a memory, wherein the processor is used for executing instructions stored in the memory, and when the instructions are executed, the processor may implement the method in the third aspect or any possible implementation of the third aspect.

In a sixteenth aspect, a computer program product containing instructions is provided. When running on a computer, the computer program product causes the computer to perform the method in the first aspect or any possible implementation of the first aspect.

In a seventeenth aspect, a computer program product containing instructions is provided. When running on a computer, the computer program product causes the computer to perform the method in the second aspect or any possible implementation of the second aspect.

In an eighteenth aspect, a computer program product containing instructions is provided. When running on a computer, the computer program product causes the computer to perform the method in the third aspect or any possible implementation of the third aspect.

### BRIEF DESCRIPTION OF DRAWINGS

FIG. 1 is a schematic diagram of architecture of an application scenario according to an implementation of the present application.

FIG. 2 is a schematic flowchart of a paging method according to an implementation of the present application.

FIG. 3 is a schematic flowchart of a paging method according to another implementation of the present application.

FIG. 4 is a schematic flowchart of a paging method according to yet another implementation of the present application.

FIG. 5 is a schematic block diagram of a terminal device according to an implementation of the present application.

FIG. 6 is a schematic block diagram of a network device according to an implementation of the present application.

FIG. 7 is a schematic block diagram of a network device according to an implementation of the present application.

FIG. 8 is a schematic diagram of structure of a terminal device according to an implementation of the present application.

FIG. 9 is a schematic diagram of structure of a network device according to an implementation of the present application.

FIG. 10 is a schematic diagram of structure of a network device according to an implementation of the present application.

FIG. 11 is a schematic diagram of structure of a system chip according to an implementation of the present application.

### DETAILED DESCRIPTION

Hereinafter, technical solutions in implementations of the present application will be described with reference to the accompanying drawings.

It should be understood that the technical solutions of the implementations of the present application may be applied to various communication systems, such as a Global System of a Mobile Communication (GSM) system, a Code Division Multiple Access (CDMA) system, a Wideband Code Division Multiple Access (WCDMA) system, a Long Term Evolution (LTE) system, a LTE Frequency Division Duplex (FDD) system, an LTE Time Division Duplex (TDD) system, a Universal Mobile Telecommunication System (UMTS), and a future 5G communication system.

Various implementations are described herein in connection with terminal devices in the present application. The terminal device may also refer to a User Equipment (UE), an access terminal, a subscriber unit, a subscriber station, a mobile station, a mobile platform, a remote station, a remote terminal, a mobile device, a user terminal, a terminal, a wireless communication device, a user agent, or a user apparatus. An access terminal may be a cellular phone, a cordless phone, a session initiation protocol (SIP) phone, a wireless local loop (WLL) station, a personal digital assistant (PDA), a handheld device with a wireless communication function, a computing device or other processing device connected to a wireless modem, an on-board device, a wearable device, a terminal device in a future 5G network, or a terminal device in a future evolved Public Land Mobile Network (PLMN), etc.

Various implementations are described herein in connection with network devices in the present application. A network device may be a device for communicating with a terminal device, such as a Base Transceiver Station (BTS) in a GSM system or CDMA, a NodeB (NB) in a WCDMA system, or an Evolutional Node B (eNB or eNodeB) in an LTE system, or the network device may be a relay station, an access point, a vehicle-mounted device, a wearable device, a network side device in a future 5G network, or a network side device in a future evolved PLMN network, etc.

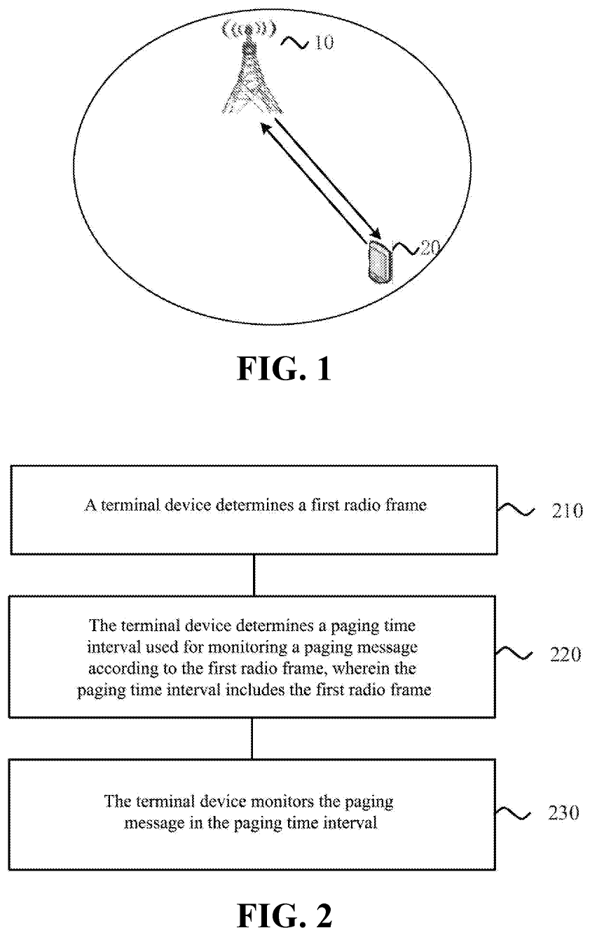

FIG. 1 is a schematic diagram of an application scenario of an implementation of the present application. A communication system in FIG. 1 may include a network device 10 and a terminal device 20. The network device 10 is used for providing communication services for the terminal device 20 and is connected to a core network. The terminal device 20 may access the network by searching for a synchronization signal, or a broadcast signal, etc., sent by the network device 10, to communicate with the network. Arrows shown in FIG. 1 may represent uplink/downlink transmission through cellular links between the terminal device 20 and the network device 10.

The network in the implementation of the present application may refer to a Public Land Mobile Network (PLMN) or a Device-to-Device (D2D) network or a Machine-to-Machine/Man (M2M) network or other networks. FIG. 1 is a simplified schematic diagram of an example, and other terminal devices may be included in the network and are not shown in FIG. 1.

When downlink data of a terminal device arrives, a network device may establish a signaling connection between the terminal device and the network device by paging the terminal device, thereby transmitting the downlink data.

A physical downlink shared channel (PDSCH) may carry paging messages of multiple terminal devices, the paging messages of the terminal devices form a paging record list, the terminal devices read each paging record in the paging record list, and each paging record includes a UE-IDentity (UE-ID) of the paged terminal device. If a terminal device finds that its UE-ID is consistent with a UE-ID in a paging record list, it may determine that it is paged by the network device.

In the 5G system, when the network device sends a paging message, the paging message may be sent in the same period as that of a downlink synchronization signal. A synchronization time interval used for the terminal device to detect a synchronization signal block (SS Block) is also a paging time interval used for the terminal device to detect the paging message. In this case, one paging time interval may include multiple paging frames (PFs) that can be used for sending a paging message. The terminal device may determine a PF used for monitoring a paging message based on a mode in the LTE, however, the terminal device cannot determine whether its own paging message is sent on the PF, because the network device may send the paging message on any PF in the paging time interval. Therefore, the terminal device needs to monitor the paging message throughout the paging time interval.

As such, the terminal device needs to know the specific time domain position of the paging time interval so as to better monitor the paging message. For example, assuming that the paging time interval includes two paging frames that can be used for sending the paging message, the terminal device determines that a system frame number (SFN) of the PF for receiving the paging message is equal to 4 based on the mode in the LTE. However, since the network device may send the paging message on any one of the two paging frames included in one paging time interval, the terminal device should monitor the paging message within the paging time interval.

For example, assuming that a paging cycle of the terminal device, namely a DRX cycle, includes N paging frames, and each paging frame can be used for transmitting a paging message. If the terminal device determines that an SFN of a certain paging frame is SFN=4, it cannot determine whether the paging message should be monitored in paging frames of SFN=3 and SFN=4, or in paging frames of SFN=4 and SFN=5, that is, it cannot determine the paging time interval where the paging message sent by the network device is located.

It should be understood that in the implementations of the present application, the discontinuous reception (DRX) cycle of the terminal device may also be referred to as the paging cycle of the terminal device. In addition, the radio frame (or system frame) that can be used for sending the paging message in the implementations of the present application may also be called the paging system frame or paging frame (PF).

In the implementations of the present application, the terminal device may determine the paging time interval used for monitoring the paging message according to the radio frame determined by the terminal device and the position of the radio frame in the paging time interval, and monitor the paging message in the paging time interval. Thus the terminal device can also effectively determine the time for receiving the paging message when a transmission period of the paging message is same as that of a common signal such as a synchronization signal.

FIG. 2 is a schematic flowchart of a paging method according to an implementation of the present application. The method shown in FIG. 2 may be performed by a terminal device, which may be, for example, the terminal device 20 shown in FIG. 1. As shown in FIG. 2, the paging method includes following acts.

In act 210, a terminal device determines a first radio frame.

In act 220, the terminal device determines a paging time interval used for monitoring a paging message according to the first radio frame, wherein the paging time interval includes the first radio frame.

In other words, each DRX cycle of the terminal device may include at least one paging time interval, and each paging time interval may include multiple paging frames that can be used for sending paging messages, and the first radio frame is included in the multiple paging frames.

Optionally, the paging time interval is same as a synchronization time interval used for detecting a synchronization signal. That is, the time period during which the terminal device monitors the paging message is same as the time period during which the terminal device detects the synchronization signal.

In act 230, the terminal device monitors the paging message in the paging time interval.

Optionally, in act 210, determining, by the terminal device, the first radio frame includes: the terminal device determines that a system frame number (SFN) of the first radio frame is SFN₁ according to SFN₁ mod T=(T/N)×(UE-ID mod N), wherein T is a time length of a DRX cycle of the terminal device, UE-ID is a device identity of the terminal device, and N is a quantity of radio frames that can be used for sending the paging message in a DRX cycle of the terminal device.

Specifically, the terminal device may determine a position of the PF that can be used for receiving its paging message, that is, an SFN of the PF, according to SFN₁ mod T=(T/N)×(UE-ID mod N), and the PF is the first radio frame. SFN₁ is an SFN of the PF, UE-ID is a device identity of the terminal device, T is a time length of a DRX cycle finally used by the terminal device, and N is a quantity of radio frames that can be used for receiving the paging message in each DRX cycle (i.e., a quantity of the PFs).

In SFN₁ mod T=(T/N)×(UE-ID mod N), T/N is equivalent to dividing each DRX cycle T into N parts, each part includes T/N radio frames, and the PF is a first radio frame in the T/N radio frames. Thus, N may be considered as a quantity of the PFs that can be used for receiving the paging message in each DRX cycle. N may be determined by N=min(T, nB), where nB may be configured by a system information block (SIB). For example, nB may be equal to 4T, 2T, T, T/2, T/4, T/8, or the like.

UE-ID mod N indicates that the terminal device selects the (UE-ID mod N)th part among the N parts (0<UE-ID mod N<N). It may be seen that which of the N parts is selected by the terminal device is determined by the UE-ID of the terminal device. The UE-ID of the terminal device may be determined by the International Mobile Subscriber Identity (IMSI) of the terminal device, for example, UE-ID=IMSI mod 1204. The terminal device selects the (UE-ID mod N)th part among the N parts, and uses the PF included in the (UE-ID mod N)th part. In this case, the system frame number SFN₁ of the PF may be determined according to SFN₁ mod T=(T/N)×(UE-ID mod N).

Optionally, in act 220, determining, by the terminal device, the paging time interval used for monitoring the paging message according to the first radio frame, includes: the terminal device receives first indication information, wherein the first indication information is used for indicating a position of the first radio frame in the paging time interval; and the terminal device determines the paging time interval according to the position of the first radio frame in the paging time interval.

For example, assuming that the paging time interval includes two radio frames (or two PFs) that can be used for transmitting a paging message, if the first indication information indicates that the first radio frame is a first PF in the paging time interval, the terminal device determines that the paging time interval includes the first radio frame and a PF after the first radio frame. If the first indication information indicates that the first radio frame is a second PF in the paging time interval, the terminal device determines that the paging time interval includes the first radio frame and a PF before the first radio frame.

Optionally, in act 220, determining, by the terminal device, the paging time interval used for monitoring the paging message according to the first radio frame, includes: the terminal device determines a position of the first radio frame in the synchronization time interval; the terminal device determines that the position of the first radio frame in the synchronization time interval is the position of the first radio frame in the paging time interval; and the terminal device determines the paging time interval according to the position of the first radio frame in the paging time interval.

Specifically, since the paging time interval is same as the synchronization time interval used for detecting the synchronization signal, the position of the first radio frame in the synchronization time interval may be considered as the position of the first radio frame in the paging time interval. So long as the terminal device determines the position of the first radio frame in the synchronization time interval of the synchronization signal such as the synchronization signal block (SS Block), the terminal device may know the position of the first radio frame in the synchronization time interval so as to determine the paging time interval according to the position of the first radio frame in the paging time interval.

Optionally, in act 220, determining, by the terminal device, the paging time interval used for monitoring the paging message according to the first radio frame, includes: the terminal device determines a second radio frame according to the first radio frame and SFN₂=Mx SFN₁, wherein an SFN of the first radio frame is SFN₁, an SFN of the second radio frame is SFN₂, and M is a quantity of radio frames included in the paging time interval; and the terminal device determines the paging time interval according to the second radio frame.

Since a time unit based on which the network device determines the paging time interval is a paging time interval, which is different from a time unit based on which the terminal device determines the first radio frame. If the paging time interval determined by the network device and used for sending the paging message includes the second radio frame (the system frame number of the second radio frame is SFN₂), the terminal device may determine the second radio frame by using SFN₂=Mx SFN₁ and the first radio frame (the system frame number of the first radio frame is SFN₁) determined by the terminal device, and determine the paging time interval according to the second radio frame.

Optionally, determining, by the terminal device, the paging time interval according to the second radio frame, includes: the terminal device receives second indication information, wherein the second indication information is used for indicating a position of the second radio frame in the paging time interval; and the terminal device determines the paging time interval according to the position of the second radio frame in the paging time interval.

For example, if SFN₁=4 and M=2 (the paging time interval includes two radio frames), the terminal device may determine SFN₂=8. If the second indication information indicates that the second radio frame is the first PF in the paging time interval, the terminal device may determine that the paging time interval includes the second radio frame and a PF after the second radio frame. If the second indication information indicates that the second radio frame is the second PF in the paging time interval, the terminal device may determine that the paging time interval includes the second radio frame and a PF before the second radio frame.

Optionally, in act 230, monitoring, by the terminal device, the paging message in the paging time interval includes: the terminal device receives third indication information, wherein the third indication information is used for indicating a third radio frame in the paging time interval; and the terminal device monitors the paging message on the third radio frame.

Specifically, the paging time interval includes multiple radio frames that can be used for sending a paging message, and the network device may send the paging message on any one of the radio frames that can be used for sending the paging message in the paging time interval. Therefore, the network device may send the third indication information to indicate to the terminal device which radio frame in the paging time interval is used for sending the paging message, so that the terminal device monitors the paging message on the radio frame, and the monitoring efficiency is improved.

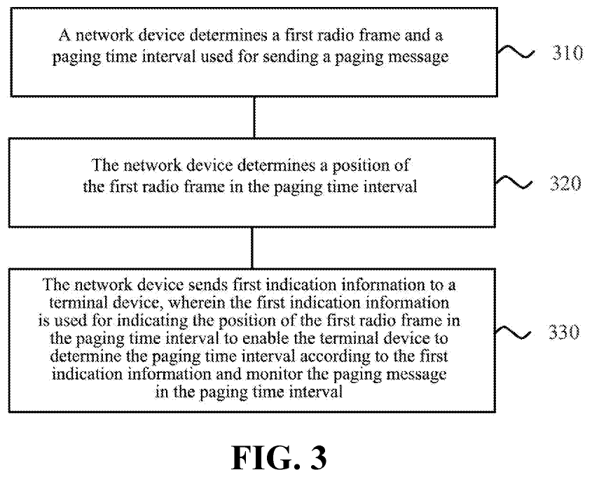

FIG. 3 is a schematic flowchart of a paging method according to an implementation of the present application. The method shown in FIG. 3 may be performed by a network device, which may be, for example, the network device 10 shown in FIG. 1. As shown in FIG. 3, the paging method includes following acts.

In act 310, a network device determines a first radio frame and a paging time interval used for sending a paging message.

In act 320, the network device determines a position of the first radio frame in the paging time interval.

In act 330, the network device sends first indication information to a terminal device, wherein the first indication information is used for indicating the position of the first radio frame in the paging time interval to enable the terminal device to determine the paging time interval according to the first indication information and monitor the paging message in the paging time interval.

Therefore, by indicating the position of a specific radio frame to the terminal device, the network device enables the terminal device to determine the paging time interval used for monitoring the paging message according to the radio frame and the position of the radio frame in the paging time interval, and to monitor the paging message in the paging time interval. Thus the terminal device can also effectively determine the time for receiving the paging message when a transmission period of the paging message is same as that of a common signal such as a synchronization signal.

Optionally, the paging time interval is same as a synchronization time interval used for detecting a synchronization signal.

Optionally, determining, by the network device, the first radio frame includes: determining, by the network device, that an SFN of the first radio frame is SFN₁ according to SFN₁ mod T=(T/N)×(UE-ID mod N), wherein T is a time length of a DRX cycle, UE-ID is a device identity of the terminal device, and N is a quantity of radio frames that can be used for sending the paging message in a DRX cycle of the terminal device.

Optionally, determining, by the network device, the position of the first radio frame in the paging time interval includes: the network device determines a position of the first radio frame in the synchronization time interval; and the network device determines that the position of the first radio frame in the synchronization time interval is the position of the first radio frame in the paging time interval.

Optionally, the method further includes the network device sends third indication information to the terminal device, wherein the third indication information is used for indicating a third radio frame in the paging time interval to enable the terminal device to monitor the paging message on the third radio frame.

It should be understood that the above description related to the terminal device in FIG. 2 may be referred to for the process of the network device determining the first radio frame and the paging time interval, which is not repeated here for the sake of brevity.

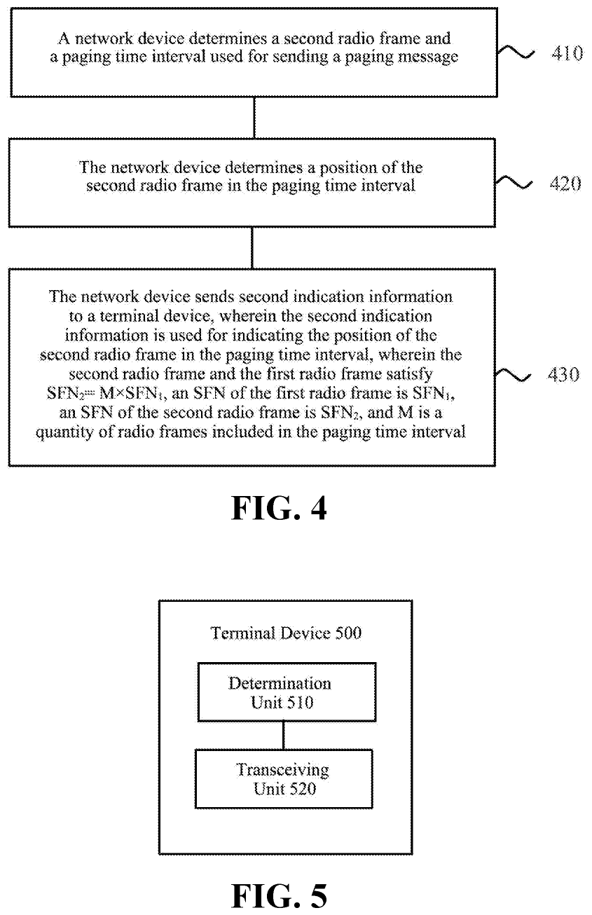

FIG. 4 is a schematic flowchart of a paging method according to an implementation of the present application. The method shown in FIG. 4 may be performed by a network device, which may be, for example, the network device 10 shown in FIG. 1. As shown in FIG. 4, the paging method includes following acts.

In act 410, a network device determines a second radio frame and a paging time interval used for sending a paging message.

In act 420, the network device determines a position of the second radio frame in the paging time interval.

In act 430, the network device sends second indication information to a terminal device, wherein the second indication information is used for indicating the position of the second radio frame in the paging time interval, to enable the terminal device to determine the second radio frame according to a first radio frame and the second indication information, determine the paging time interval according to the second radio frame, and monitor the paging message in the paging time interval.

The second radio frame and the first radio frame satisfy SFN₂=Mx SFN₁, an SFN of the first radio frame is SFN₁, an SFN of the second radio frame is SFN₂, and M is a quantity of radio frames included in the paging time interval.

Therefore, by indicating the position of a specific radio frame to the terminal device, the network device enables the terminal device to determine the paging time interval used for monitoring the paging message according to the radio frame and the position of the radio frame in the paging time interval, and to monitor the paging message in the paging time interval. Thus the terminal device can also effectively determine the time for receiving the paging message when a transmission period of the paging message is the same as that of a common signal such as a synchronization signal.

Optionally, the paging time interval is same as a synchronization time interval used for detecting a synchronization signal.

Optionally, the first radio frame satisfies SFN₁ mod T=(T/N)×(UE-ID mod N), and the SFN of the first radio frame is determined as the SFN₁, wherein T is a time length of a DRX cycle, UE-ID is a device identity of the terminal device, and N is a quantity of radio frames that can be used for sending the paging message in a DRX cycle of the terminal device.

It should be understood that the above description related to the terminal device in FIG. 2 may be referred to for the process of the network device determining the second radio frame and the paging time interval, which is not repeated here for the sake of brevity.

It should be understood that in various implementations of the present invention, values of sequence numbers in the above processes do not indicate an order of execution, and the order of execution of various processes should be determined by their functions and internal logics, and should not constitute any limitation on implementation processes of implementations of the present application.

FIG. 5 is a schematic block diagram of a terminal device 500 according to an implementation of the present application. As shown in FIG. 5, the terminal device 500 includes a determination unit 510 and a transceiving unit 520.

The determination unit 510 is used for determining a first radio frame.

The determination unit 510 is further used for determining a paging time interval used for monitoring a paging message according to the first radio frame, wherein the paging time interval includes the first radio frame.

The transceiving unit 520 is used for monitoring the paging message in the paging time interval.

Therefore, the terminal device may determine the paging time interval used for monitoring the paging message according to a radio frame determined by the terminal device and a position of the radio frame in the paging time interval, and monitor the paging message in the paging time interval. Thus the terminal device can also effectively determine the time for receiving the paging message when a transmission period of the paging message is same as that of a common signal such as a synchronization signal.

Optionally, the paging time interval is same as a synchronization time interval used for detecting a synchronization signal.

Optionally, the determination unit 510 is specifically used for: determining that an SFN of the first radio frame is SFN₁ according to SFN₁ mod T=(T/N)×(UE-ID mod N), wherein T is a time length of a discontinuous reception (DRX) cycle, UE-ID is a device identity of the terminal device, and N is a quantity of radio frames that can be used for sending the paging message in a DRX cycle of the terminal device.

Optionally, the transceiving unit 520 is further used for receiving first indication information, wherein the first indication information is used for indicating a position of the first radio frame in the paging time interval; the determination unit 510 is specifically used for determining the paging time interval according to the position of the first radio frame in the paging time interval.

Optionally, the determination unit 510 is specifically used for determining a position of the first radio frame in the synchronization time interval, determining that the position of the first radio frame in the synchronization time interval is the position of the first radio frame in the paging time interval, and determining the paging time interval according to the position of the first radio frame in the paging time interval.

Optionally, the determination unit 510 is specifically used for: determining a second radio frame according to the first radio frame and SFN₂=Mx SFN₁, wherein an SFN of the first radio frame is SFN₁, an SFN of the second radio frame is SFN₂, and M is a quantity of radio frames included in the paging time interval; and determining the paging time interval according to the second radio frame.

Optionally, the transceiving unit 520 is further used for: receiving second indication information, wherein the second indication information is used for indicating a position of the second radio frame in the paging time interval; the determination unit 510 is specifically used for determining the paging time interval according to the position of the second radio frame in the paging time interval.

Optionally, the transceiving unit 520 is specifically used for: receiving third indication information, wherein the third indication information is used for indicating a third radio frame in the paging time interval; and monitoring the paging message on the third radio frame.

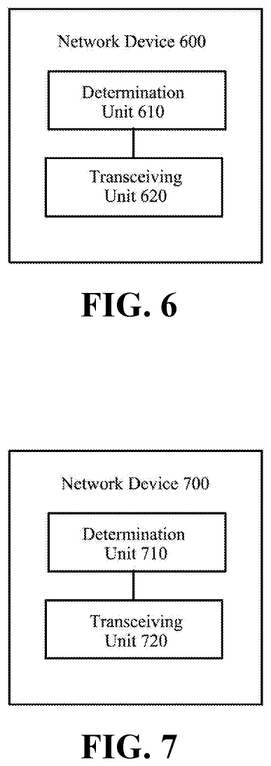

FIG. 6 is a schematic block diagram of a network device 600 according to an implementation of the present application. As shown in FIG. 6, the network device 600 includes a determination unit 610 and a transceiving unit 620.

The determination unit 610 is used for determining a first radio frame and a paging time interval used for sending a paging message.

The determination unit 610 is further used for determining a position of the first radio frame in the paging time interval.

The transceiving unit 620 is used for sending first indication information to a terminal device, wherein the first indication information is used for indicating a position of the first radio frame in the paging time interval to enable the terminal device to determine the paging time interval according to the first indication information and monitor the paging message in the paging time interval.

Therefore, by indicating the position of a specific radio frame to the terminal device, the network device enables the terminal device to determine the paging time interval used for monitoring the paging message according to the radio frame and the position of the radio frame in the paging time interval, and to monitor the paging message in the paging time interval. Thus the terminal device can effectively determine the time for receiving the paging message when a transmission period of the paging message is same as that of a common signal such as a synchronization signal.

Optionally, the paging time interval is same as a synchronization time interval used for detecting a synchronization signal.

Optionally, the determination unit 610 is specifically used for determining that an SFN of the first radio frame is SFN₁ according to SFN₁ mod T=(T/N)×(UE-ID mod N), wherein T is a time length of a DRX cycle, UE-ID is a device identity of the terminal device, and N is a quantity of radio frames that can be used for sending the paging message in a DRX cycle of the terminal device.

Optionally, the determination unit 610 is specifically used for determining a position of the first radio frame in the synchronization time interval and determining that the position of the first radio frame in the synchronization time interval is the position of the first radio frame in the paging time interval.

Optionally, the transceiving unit 620 is further used for sending third indication information to the terminal device, wherein the third indication information is used for indicating a third radio frame in the paging time interval to enable the terminal device to monitor the paging message on the third radio frame.

FIG. 7 is a schematic block diagram of a network device 700 according to an implementation of the present application. As shown in FIG. 7, the network device 700 includes a determination unit 710 and a transceiving unit 720.

The determination unit 710 is used for determining a second radio frame and a paging time interval used for sending a paging message.

The determination unit 710 is further used for determining a position of the second radio frame in the paging time interval.

The transceiving unit 720 is used for sending second indication information to a terminal device, wherein the second indication information is used for indicating the position of the second radio frame in the paging time interval to enable the terminal device to determine the second radio frame according to a first radio frame and the second indication information, determine the paging time interval according to the second radio frame, and monitor the paging message in the paging time interval.

The second radio frame and the first radio frame satisfy SFN₂=Mx SFN₁, an SFN of the first radio frame is SFN₁, an SFN of the second radio frame is SFN₂, and M is a quantity of radio frames included in the paging time interval.

Therefore, by indicating the position of a specific radio frame to the terminal device, the network device enables the terminal device to determine the paging time interval used for monitoring the paging message according to the radio frame and the position of the radio frame in the paging time interval, and to monitor the paging message in the paging time interval. Thus the terminal device can also effectively determine the time for receiving the paging message when a transmission period of the paging message is same as that of a common signal such as a synchronization signal.

Optionally, the paging time interval is same as a synchronization time interval used for detecting a synchronization signal.

Optionally, the first radio frame satisfies SFN₁ mod T=(T/N)×(UE-ID mod N), and the SFN of the first radio frame is determined as the SFN₁, wherein T is a time length of a DRX cycle, UE-ID is a device identity of the terminal device, and N is a quantity of radio frames that can be used for sending the paging message in a DRX cycle of the terminal device.

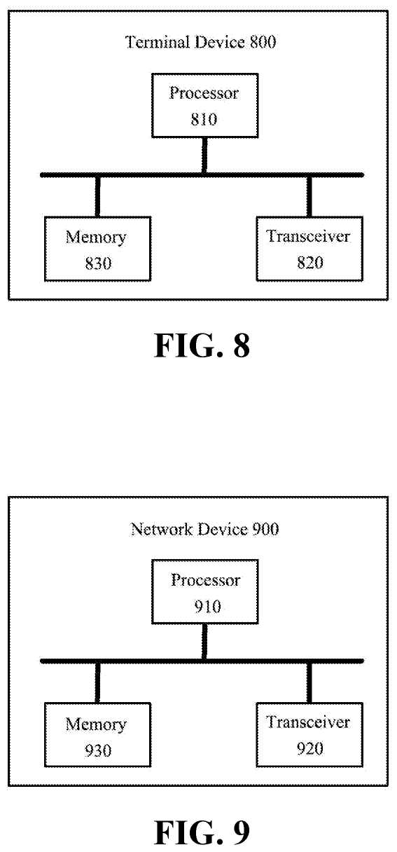

FIG. 8 is a schematic diagram of structure of a terminal device 800 according to an implementation of the present application. As shown in FIG. 8, the terminal device includes a processor 810, a transceiver 820, and a memory 830. The processor 810, the transceiver 820, and the memory 830 communicate with each other through an internal connection path. The memory 830 is used for storing instructions, and the processor 810 is used for executing the instructions stored in the memory 830 to control the transceiver 820 to send or receive signals. The processor 810 is used for determining a first radio frame and determining a paging time interval used for monitoring a paging message according to the first radio frame, wherein the paging time interval includes the first radio frame.

The transceiver 820 is used for monitoring the paging message in the paging time interval.

Therefore, the terminal device may determine the paging time interval used for monitoring the paging message according to the radio frame determined by the terminal device and a position of the radio frame in the paging time interval, and monitor the paging message in the paging time interval. Thus the terminal device can effectively determine the time for receiving the paging message when a transmission period of the paging message is same as that of a common signal such as a synchronization signal.

Optionally, the paging time interval is same as a synchronization time interval used for detecting a synchronization signal.

Optionally, the processor 810 is specifically used for determining that an SFN of the first radio frame is SFN₁ according to SFN₁ mod T=(T/N)×(UE-ID mod N), wherein T is a time length of a DRX cycle, UE-ID is a device identity of the terminal device, and N is a quantity of radio frames that can be used for sending the paging message in a DRX cycle of the terminal device.

Optionally, the transceiver 820 is further used for receiving first indication information, wherein the first indication information is used for indicating a position of the first radio frame in the paging time interval.

The processor 810 is specifically used for determining the paging time interval according to the position of the first radio frame in the paging time interval.

Optionally, the processor 810 is specifically used for determining a position of the first radio frame in the synchronization time interval, determining that the position of the first radio frame in the synchronization time interval is the position of the first radio frame in the paging time interval, and determining the paging time interval according to the position of the first radio frame in the paging time interval.

Optionally, the processor 810 is specifically used for: determining a second radio frame according to the first radio frame and SFN₂=Mx SFN₁, wherein an SFN of the first radio frame is SFN₁, an SFN of the second radio frame is SFN₂, and M is a quantity of radio frames included in the paging time interval; and determining, by the terminal device, the paging time interval according to the second radio frame.

Optionally, the transceiver 820 is further used for receiving second indication information, wherein the second indication information is used for indicating a position of the second radio frame in the paging time interval.

The processor 810 is specifically used for determining the paging time interval according to the position of the second radio frame in the paging time interval.

Optionally, the transceiver 820 is specifically used for: receiving third indication information, wherein the third indication information is used for indicating a third radio frame in the paging time interval; and monitoring the paging message on the third radio frame.

It should be understood that, in an implementation of the present application, the processor 810 may be a central processing unit (CPU), or the processor 810 may be another general purpose processor, a digital signal processor (DSP), an application specific integrated circuit (ASIC), a field programmable gate array (FPGA) or another programmable logic device, a discrete gate or transistor logic device, or a discrete hardware component. The general purpose processor may be a microprocessor or the processor may be any conventional processor or the like.

The memory 830 may include a read-only memory and a random access memory, and provide instructions and data to the processor 810. A portion of memory 830 may include a non-volatile random access memory.

In an implementation process, the acts of the methods described above may be accomplished by integrated logic circuits of hardware in the processor 810 or instructions in a form of software. The acts of the paging method disclosed in the implementation of the present application may be directly accomplished by an execution of a hardware processor or accomplished by a combination of hardware and software modules in the processor 810. The software modules may be located in a storage medium commonly used in the art, such as a random access memory, flash memory, read-only memory, programmable read-only memory or electrically erasable programmable memory, or register. The storage medium is located in the memory 830, and the processor 810 reads the information in the memory 830 and accomplishes the acts of the above method in combination with its hardware. In order to avoid repetition, it will not be described in detail here.

The terminal device 800 according to the implementation of the present application may correspond to the terminal device for executing the method 200 in the method 200 and the terminal device 400 according to the implementation of the present application, and various units or modules in the terminal device 800 are respectively used for executing various actions or processing processes executed by the terminal device in the method 200. Here, in order to avoid redundancy, detailed description thereof is omitted.

FIG. 9 is a schematic diagram of structure of a network device 900 according to an implementation of the present application. As shown in FIG. 9, the network device includes a processor 910, a transceiver 920, and a memory 930. The processor 910, the transceiver 920, and the memory 930 communicate with each other through an internal connection path. The memory 930 is used for storing instructions, and the processor 910 is used for executing the instructions stored in the memory 930 to control the transceiver 920 to send or receive signals. The processor 910 is used for determining a first radio frame and a paging time interval used for sending a paging message, and determining a position of the first radio frame in the paging time interval.

The transceiver 920 is used for sending first indication information to a terminal device, wherein the first indication information is used for indicating a position of the first radio frame in the paging time interval to enable the terminal device to determine the paging time interval according to the first indication information and monitor the paging message in the paging time interval.

Therefore, by indicating the position of a specific radio frame to the terminal device, the network device enables the terminal device to determine the paging time interval used for monitoring the paging message according to the radio frame and the position of the radio frame in the paging time interval, and to monitor the paging message in the paging time interval. Thus the terminal device can also effectively determine the time for receiving the paging message when a transmission period of the paging message is same as that of a common signal such as a synchronization signal.

Optionally, the paging time interval is same as a synchronization time interval used for detecting a synchronization signal.

Optionally, the processor 910 is specifically used for determining that an SFN of the first radio frame is SFN₁ according to SFN₁ mod T=(T/N)×(UE-ID mod N), wherein T is a time length of a DRX cycle, UE-ID is a device identity of the terminal device, and N is a quantity of radio frames that can be used for sending the paging message in a DRX cycle of the terminal device.

Optionally, the processor 910 is specifically used for determining a position of the first radio frame in the synchronization time interval and determining that the position of the first radio frame in the synchronization time interval is the position of the first radio frame in the paging time interval.

Optionally, the transceiver 920 is further used for sending third indication information to the terminal device, wherein the third indication information is used for indicating a third radio frame in the paging time interval to enable the terminal device to monitor the paging message on the third radio frame.

It should be understood that in an implementation of the present application, the processor 910 may be a central processing unit (CPU), or the processor 910 may be another general purpose processor, a digital signal processor (DSP), an application specific integrated circuit (ASIC), a field programmable gate array (FPGA) or another programmable logic device, a discrete gate or transistor logic device, or a discrete hardware component. The general purpose processor may be a microprocessor or the processor may be any conventional processor or the like.

The memory 930 may include a read-only memory and a random access memory, and provide instructions and data to the processor 910. A portion of memory 930 may include non-volatile random access memory. In an implementation process, the acts of the methods described above may be accomplished by integrated logic circuits of hardware in the processor 910 or instructions in a form of software. The acts of the paging method disclosed in the implementation of the present application may be directly accomplished by an execution of a hardware processor or accomplished by a combination of hardware and software modules in the processor 910. The software modules may be located in a storage medium commonly used in the art, such as a random access memory, flash memory, read-only memory, programmable read-only memory or electrically erasable programmable memory, or register. The storage medium is located in the memory 930, and the processor 910 reads the information in the memory 930 and accomplishes the acts of the above method in combination with its hardware. In order to avoid repetition, it will not be described in detail here.

The network device 900 according to the implementation of the present application may correspond to the network device for executing the method 300 in the method 300 and the network device 600 according to the implementation of the present application, and various units or modules in the network device 900 are respectively used for executing various actions or processing processes executed by the network device in the method 300. Here, in order to avoid redundancy, detailed description thereof is omitted.

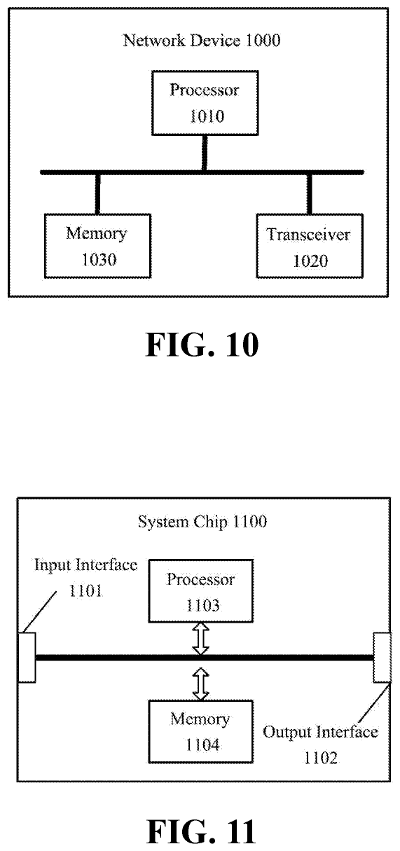

FIG. 10 is a schematic diagram of structure of a network device 1000 according to an implementation of the present application. As shown in FIG. 10, the network device includes a processor 1010, a transceiver 1020, and a memory 1030, wherein the processor 1010, the transceiver 1020, and the memory 1030 communicate with each other through an internal connection path. The memory 1030 is used for storing instructions, and the processor 1010 is used for executing the instructions stored in the memory 1030 to control the transceiver 1020 to send or receive signals. The processor 1010 is used for determining a second radio frame and a paging time interval used for sending a paging message, and determining a position of the second radio frame in the paging time interval.

The transceiver 1020 is used for sending second indication information to a terminal device, wherein the second indication information is used for indicating a position of the second radio frame in the paging time interval to enable the terminal device to determine the second radio frame according to a first radio frame and the second indication information, determine the paging time interval according to the second radio frame, and monitor the paging message in the paging time interval.

The second radio frame and the first radio frame satisfy SFN₂=Mx SFN₁, an SFN of the first radio frame is SFN₁, an SFN of the second radio frame is SFN₂, and M is a quantity of radio frames included in the paging time interval.

Therefore, by indicating the position of a specific radio frame to the terminal device, the network device enables the terminal device to determine the paging time interval used for monitoring the paging message according to the radio frame and the position of the radio frame in the paging time interval, and to monitor the paging message in the paging time interval. Thus the terminal device can also effectively determine the time for receiving the paging message when a transmission period of the paging message is the same as that of a common signal such as a synchronization signal.

Optionally, the paging time interval is same as a synchronization time interval used for detecting a synchronization signal.

Optionally, the first radio frame satisfies SFN₁ mod T=(T/N)×(UE-ID mod N), and the SFN of the first radio frame is determined as the SFN₁, wherein T is a time length of a DRX cycle, UE-ID is a device identity of the terminal device, and N is a quantity of radio frames that can be used for sending the paging message in a DRX cycle of the terminal device.

It should be understood that in an implementation of the present application, the processor 1010 may be a central processing unit (CPU), or the processor 1010 may be another general purpose processor, a digital signal processor (DSP), an application specific integrated circuit (ASIC), a field programmable gate array (FPGA) or another programmable logic device, a discrete gate or transistor logic device, or a discrete hardware component. The general purpose processor may be a microprocessor or the processor may be any conventional processor or the like.

The memory 1030 may include a read-only memory and a random access memory, and provide instructions and data to the processor 1010. A portion of the memory 1030 may include a non-volatile random access memory. In an implementation process, the acts of the methods described above may be accomplished by integrated logic circuits of hardware in the processor 1010 or instructions in a form of software. The acts of the paging method disclosed in the implementation of the present application may be directly accomplished by an execution of a hardware processor or accomplished by a combination of hardware and software modules in the processor 1010. The software modules may be located in a storage medium commonly used in the art, such as a random access memory, flash memory, read-only memory, programmable read-only memory or electrically erasable programmable memory, or register. The storage medium is located in the memory 1030, and the processor 1010 reads the information in the memory 1030 and accomplishes the acts of the above method in combination with its hardware. In order to avoid repetition, it will not be described in detail here.

The network device 1000 according to the implementation of the present application may correspond to the network device for executing in the method 400 and the network device 700 according to the implementation of the present application, and various units or modules in the network device 1000 are respectively used for executing various actions or processing processes executed by the network device in the method 400. Here, in order to avoid redundancy, detailed description thereof is omitted.

FIG. 11 is a schematic diagram of structure of a system chip according to an implementation of the present application. The system chip 1100 of FIG. 11 includes an input interface 1101, an output interface 1102, at least one processor 1103, and a memory 1104. The input interface 1101, the output interface 1102, the processor 1103, and the memory 1104 are connected to each other through an internal connection path. The processor 1103 is used for executing codes in the memory 1104.

Optionally, the processor 1103 may implement the method 200 executed by the terminal device in the method implementation when the codes are executed. For the sake of brevity, it will not be repeated here.

Optionally, the processor 1103 may implement the method 300 executed by the network device in the method implementation when the codes are executed. For the sake of brevity, it will not be repeated here.

Optionally, the processor 1103 may implement the method 400 executed by the network device in the method implementation when the codes are executed. For the sake of brevity, it will not be repeated here.

Those of ordinary skill in the art will recognize that the example units and algorithm acts described in connection with the implementations disclosed herein may be implemented in electronic hardware, or a combination of computer software and electronic hardware. Whether these functions are implemented in hardware or software depends on a specific application and design constraint of the technical solution. Skilled in the art may use different manners to realize the described functions for each particular application, but such realization should not be considered to be beyond the scope of the present application.

Those skilled in the art may clearly understand that for convenience and conciseness of description, the specific working process of the system, device and unit described above may refer to the corresponding process in the aforementioned implementations of methods, and details are not described herein again.

In several implementations provided by the present application, it should be understood that the disclosed system, device and method may be implemented in other ways. For example, the device implementation described above is only illustrative, for example, the division of the unit is only a logical function division, and there may be other ways of division in actual implementation, for example, multiple units or components may be combined or integrated into another system, or some features may be ignored or not executed. On the other hand, the mutual coupling or direct coupling or communication connection shown or discussed may be indirect coupling or communication connection through some interfaces, devices or units, and may be in electrical, mechanical or other forms.

The units described as separate components may or may not be physically separated, and the component shown as a unit may or may not be a physical unit, i.e., may be located in one place or may be distributed over multiple network units. Some or all of the units may be selected according to practical needs to achieve a purpose of the solution of the implementations.

In addition, various functional units in various implementations of the present application may be integrated in one monitoring unit, or various units may be physically present separately, or two or more units may be integrated in one unit.

The functions may be stored in a computer readable storage medium if implemented in a form of software functional units and sold or used as a separate product. Based on this understanding, the technical solution of the present application, in essence, or the part contributing to the existing art, or the part of the technical solution, may be embodied in the form of a software product stored in a storage medium, including several instructions for causing a computer device (which may be a personal computer, a server, or a network device, etc.) to perform all or part of the acts of the methods described in various implementations of the present application. The aforementioned storage medium includes various media capable of storing program codes, such as a U disk, a mobile hard disk, a read-only memory (ROM), a random access memory (RAM), a magnetic disk, or an optical disk.

What are described above are merely example implementations of the present application, but the protection scope of the present application is not limited thereto. Any variation or substitution that may be easily conceived by a person skilled in the art within the technical scope disclosed by the present application shall be included within the protection scope of the present application. Therefore, the protection scope of the implementations of the present application should be based on the protection scope of the claims.

1. A method for paging, comprising:
determining, by a terminal device, a first radio frame;
determining, by the terminal device, a paging time interval used for monitoring a paging message according to the first radio frame, wherein the paging time interval comprises the first radio frame; and
monitoring, by the terminal device, the paging message in the paging time interval.

2. The method according to claim 1, wherein the paging time interval is same as a synchronization time interval used for detecting a synchronization signal.

3. The method according to claim 1, wherein determining, by the terminal device, the first radio frame comprises:
determining, by the terminal device, that a system frame number (SFN) of the first radio frame is SFN₁ according to SFN₁ mod T=(T/N)×(UE-ID mod N), wherein T is a time length of a discontinuous reception (DRX) cycle, UE-ID is a device identity of the terminal device, and N is a quantity of radio frames that are able to be used for sending the paging message in a DRX cycle of the terminal device.

4. The method according to claim 1, wherein determining, by the terminal device, the paging time interval used for monitoring the paging message according to the first radio frame, comprises:
receiving, by the terminal device, first indication information, wherein the first indication information is used for indicating a position of the first radio frame in the paging time interval; and
determining, by the terminal device, the paging time interval according to the position of the first radio frame in the paging time interval.

5. The method according to claim 2, wherein determining, by the terminal device, the paging time interval used for monitoring the paging message according to the first radio frame, comprises:
determining, by the terminal device, a position of the first radio frame in the synchronization time interval;
determining, by the terminal device, that the position of the first radio frame in the synchronization time interval is the position of the first radio frame in the paging time interval; and
determining, by the terminal device, the paging time interval according to the position of the first radio frame in the paging time interval.

6. The method according to claim 1, wherein determining, by the terminal device, the paging time interval used for monitoring the paging message according to the first radio frame, comprises:
determining, by the terminal device, a second radio frame according to the first radio frame and SFN₂=M×SFN₁, wherein an SFN of the first radio frame is SFN₁, an SFN of the second radio frame is SFN₂, and M is a quantity of radio frames comprised in the paging time interval; and
determining, by the terminal device, the paging time interval according to the second radio frame.

7. The method according to claim 6, wherein determining, by the terminal device, the paging time interval according to the second radio frame, comprises:
receiving, by the terminal device, second indication information, wherein the second indication information is used for indicating a position of the second radio frame in the paging time interval; and
determining, by the terminal device, the paging time interval according to the position of the second radio frame in the paging time interval.

8. The method according to claim 1, wherein monitoring, by the terminal device, the paging message in the paging time interval comprises:
receiving, by the terminal device, third indication information, wherein the third indication information is used for indicating a third radio frame in the paging time interval; and
monitoring, by the terminal device, the paging message on the third radio frame.

9. A method for paging, comprising:
determining, by a network device, a first radio frame and a paging time interval used for sending a paging message;
determining, by the network device, a position of the first radio frame in the paging time interval; and
sending, by the network device, first indication information to a terminal device, wherein the first indication information is used for indicating the position of the first radio frame in the paging time interval, to enable the terminal device to determine the paging time interval according to the first indication information and monitor the paging message in the paging time interval.

10. The method according to claim 9, wherein the paging time interval is same as a synchronization time interval used for detecting a synchronization signal.

11. The method according to claim 9 or 10, wherein determining, by the network device, the first radio frame comprises:
determining, by the network device, that a system frame number (SFN) of the first radio frame is SFN₁ according to SFN₁ mod T=(T/N)×(UE-ID mod N), wherein T is a time length of a discontinuous reception (DRX) cycle, UE-ID is a device identity of the terminal device, and N is a quantity of radio frames that are able to be used for sending the paging message in a DRX cycle of the terminal device.

12. The method according to claim 10 or 11, wherein determining, by the network device, the position of the first radio frame in the paging time interval comprises:
determining, by the network device, a position of the first radio frame in the synchronization time interval; and
determining, by the network device, that the position of the first radio frame in the synchronization time interval is the position of the first radio frame in the paging time interval.

13. The method according to claim 9, wherein the method further comprises:
sending, by the network device, third indication information to the terminal device, wherein the third indication information is used for indicating a third radio frame in the paging time interval to enable the terminal device to monitor the paging message on the third radio frame.

14-16. (canceled)

17. A terminal device, comprising:
a processor used for determining a first radio frame and determining a paging time interval used for monitoring a paging message according to the first radio frame, wherein the paging time interval comprises the first radio frame; and
a transceiver used for monitoring the paging message in the paging time interval determined by the processor.

18. The terminal device according to claim 17, wherein the paging time interval is same as a synchronization time interval used for detecting a synchronization signal.

19. The terminal device according to claim 17, wherein the processor is specifically used for
determining that a system frame number (SFN) of the first radio frame is SFN₁ according to SFN₁ mod T=(T/N)×(UE-ID mod N), wherein T is a time length of a discontinuous reception (DRX) cycle, UE-ID is a device identity of the terminal device, and N is a quantity of radio frames that are able to be used for sending the paging message in a DRX cycle of the terminal device.

20. The terminal device according to claim 17, wherein the transceiver is further used for receiving first indication information, wherein the first indication information is used for indicating a position of the first radio frame in the paging time interval; and
the processor is specifically used for: determining the paging time interval according to the position of the first radio frame in the paging time interval.

21. The terminal device according to claim 18, wherein the processor is specifically used for:
determining a position of the first radio frame in the synchronization time interval;
determining that the position of the first radio frame in the synchronization time interval is the position of the first radio frame in the paging time interval; and
determining the paging time interval according to the position of the first radio frame in the paging time interval.

22. The terminal device according to claim 17, wherein the processor is specifically used for determining a second radio frame according to the first radio frame and SFN₂=M×SFN₁, wherein an SFN of the first radio frame is SFN₁, an SFN of the second radio frame is SFN₂, and M is a quantity of radio frames comprised in the paging time interval; and
determining the paging time interval according to the second radio frame.

23. The terminal device according to claim 22, wherein the transceiver is further used for receiving second indication information, wherein the second indication information is used for indicating a position of the second radio frame in the paging time interval; and
the processor is specifically used for determining the paging time interval according to the position of the second radio frame in the paging time interval.

24. The terminal device according to claim 17, wherein the transceiver is specifically used for receiving third indication information, wherein the third indication information is used for indicating a third radio frame in the paging time interval; and
monitoring the paging message on the third radio frame.

25. A network device, comprising:
a processor used for determining a first radio frame and a paging time interval used for sending a paging message and determining a position of the first radio frame in the paging time interval; and
a transceiver used for sending first indication information to a terminal device, wherein the first indication information is used for indicating the position of the first radio frame in the paging time interval to enable the terminal device to determine the paging time interval according to the first indication information and monitor the paging message in the paging time interval.

26. The network device according to claim 25, wherein the paging time interval is same as a synchronization time interval used for detecting a synchronization signal.

27. The network device according to claim 25, wherein the processor is specifically used for determining that a system frame number (SFN) of the first radio frame is SFN₁ according to SFN₁ mod T=(T/N)×(UE-ID mod N), wherein T is a time length of a discontinuous reception (DRX) cycle, UE-ID is a device identity of the terminal device, and N is a quantity of radio frames that are able to be used for sending the paging message in a DRX cycle of the terminal device.

28. The network device according to claim 26, wherein the processor is specifically used for: determining a position of the first radio frame in the synchronization time interval; and
determining that the position of the first radio frame in the synchronization time interval is the position of the first radio frame in the paging time interval.

29. The network device according to claim 25, wherein the transceiver is further used for sending third indication information to the terminal device, wherein the third indication information is used for indicating a third radio frame in the paging time interval to enable the terminal device to monitor the paging message on the third radio frame.

30-32. (canceled)
